(19) United States
(12) Patent Application Publication
(10) Pub. No.: US 2009/0116116 A1
(43) Pub. Date: May 7, 2009

(54) DISPLAY DEVICE

(76) Inventors: Masahiko TOMIKAWA, Kumagaya-shi (JP); Takashi Sasabayashi, Konosu-shi (JP); Keiichi Moriyama, Fukaya-shi (JP); Ryoichi Watanabe, Fukaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/261,345

(22) Filed: Oct. 30, 2008

(30) Foreign Application Priority Data
Nov. 2, 2007 (JP) 2007-286546

(51) Int. Cl. G02B 27/12

(52) U.S. Cl. 359/619

(57) ABSTRACT

A display device includes a lens array unit including a lens array layer, and a display unit configured such that a first substrate and a second substrate, which is disposed between the first substrate and the lens array unit, are attached, the display unit including a display area and an alignment mark outside the display area, wherein the lens array unit includes a window portion formed at a position on the lens array layer, which corresponds to the alignment mark.

### CROSS-REFERENCE TO RELATED APPLICATIONS

This application is based upon and claims the benefit of priority from prior Japanese Patent Application No. 2007-286546, filed Nov. 2, 2007, the entire contents of which are incorporated herein by reference.

### BACKGROUND OF THE INVENTION

1. Field of the Invention

The present invention relates to a display device, and more particularly to a stereoscopic video display device including a lens array unit.

2. Description of the Related Art

There are known various types of stereoscopic image display devices, so-called 3D displays, which can display motion video. In recent years, there has been an increasing demand, in particular, for a flat-panel type stereoscopic image display device which requires no dedicated goggles or the like. Of this type of stereoscopic motion video display devices, a stereoscopic motion video display device, which makes use of the principle of holography, has difficulty in realizing full-color motion video display. On the other hand, full-color motion video display is relatively easily realizable with a direct-view-type or projection-type liquid crystal display device or plasma display device, wherein a light ray control element, which controls light rays from a display unit (display device) with fixed pixel positions and turns the light rays to a viewer, is disposed immediately in front of the display unit.

This light ray control element is generally called “parallax barrier”. The light ray control element controls light rays so that different images can be viewed depending on angles, even at the same position on the light ray control element. Specifically, when only right-and-left parallax (horizontal parallax) is imparted, a slit or a lenticular lens sheet (cylindrical lens array) is used. In the case where up-and-down parallax (vertical parallax) is also imparted, a pinhole array or a lens array comprising matrix-arrayed lenses is used. The methods using parallax barriers are further classified into a two-view (binocular) type, a multi-view type, a super-multi-view type (super-multi-view condition of a multi-view type), and integral photography (hereinafter also referred to as “IP”). The basic principle of these methods is substantially the same as the principle that was invented about 100 years ago, and has been used in the field of stereoscopic photography.

Of these methods, the IP method is characterized by a high degree of freedom of view-point position and easy realization of stereoscopic view. In a one-dimensional IP method in which only horizontal parallax is provided and vertical parallax is not provided, a display device with high resolution is relatively easily realized (see, e.g. SID04 Digest 1438 (2004)). On the other hand, as regards the two-view type and multi-view type, there is a problem that the range of viewing-point position which permits stereoscopic view, that is, the visual range, is narrow and there is difficulty in viewing. However, these types are simplest in structure as stereoscopic image display devices, and a display image can easily be created.

A lens array unit, which is one of light ray control elements, is disposed so as to be opposed to a display area of the display unit. In the case of using a lens array unit comprising a plurality of cylindrical lenses, the lens array unit is disposed such that a plurality of pixels of the display area correspond to the respective cylindrical lenses. It is thus important to exactly align the lens array unit and the display unit. Various techniques have been disclosed for aligning the lens array unit and the display unit. For instance, there is disclosed a technique wherein the lens array unit and the display unit are aligned by means of markers on the lens array unit side and markers on the display unit side (see Jpn. Pat. Appln. KOKAI Publication No. 2004-280087).

According to the above-mentioned patent document, the markers on the lens array unit side and the markers on the display unit side are formed of color patterns. By viewing both markers, the lens array unit and display unit are aligned. However, when forming the lens array unit, an additional member for forming the markers is required, leading to an increase in cost. In addition, since an additional fabrication step for forming the markers is required, there is a concern that the yield of lens array units may lower.

### BRIEF SUMMARY OF THE INVENTION

The present invention has been made in consideration of the above-described problems, and the object of the invention is to provide a display device which can obtain desired display characteristics, while suppressing an increase in cost and a decrease in yield.

According to an aspect of the present invention, there is provided a display device comprising: a lens array unit including a lens array layer; and a display unit configured such that a first substrate and a second substrate, which is disposed between the first substrate and the lens array unit, are attached, the display unit including a display area and an alignment mark outside the display area, wherein the lens array unit includes a window portion formed at a position on the lens array layer, which corresponds to the alignment mark.

The present invention can provide a display device which can obtain desired display characteristics, while suppressing an increase in cost and a decrease in yield.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 schematically shows the structure of a display device according to an embodiment of the present invention;

FIG. 2 schematically shows the structure of a display unit (liquid crystal display panel) which is applicable to the display device shown in FIG. 1;

FIG. 3 schematically shows a cross-sectional structure of the display unit shown in FIG. 2;

FIG. 4A is a perspective view that schematically shows one structure of a lens array unit which is applicable to the display device shown in FIG. 1;

FIG. 4B is a perspective view that schematically shows another structure of the lens array unit which is applicable to the display device shown in FIG. 1;

FIG. 5 is a plan view that schematically shows one structure of a lens array layer which is applicable to the display device shown in FIG. 1;

FIG. 6 is a plan view that schematically shows another structure of the lens array layer which is applicable to the display device shown in FIG. 1;

FIG. 7 is a perspective view for describing alignment between the lens array unit and the display unit, which are applicable to the display device shown in FIG. 1;

FIG. 8 is an enlarged view of a region A shown in FIG. 7;

FIG. 9A is a cross-sectional view that schematically shows one structure of a lens array unit which is applicable to the display device shown in FIG. 1;

FIG. 9B is a cross-sectional view that schematically shows another structure of the lens array unit which is applicable to the display device shown in FIG. 1;

FIG. 9C is a cross-sectional view that schematically shows still another structure of the lens array unit which is applicable to the display device shown in FIG. 1;

FIG. 10 is a cross-sectional view that schematically shows still another structure example of the lens array unit which is applicable to the embodiment;

FIG. 11 is a cross-sectional view that schematically shows still another structure example of the lens array unit which is applicable to the embodiment;

FIG. 12 is a perspective view that schematically shows the entire structure of a stereoscopic image display device according to an embodiment of the invention;

FIG. 13A is front view of the display unit and lens array unit;

FIG. 13B is a plan view showing an arrangement of images of the stereoscopic video device;

FIG. 13C is a side view of the stereoscopic video device; and

FIG. 14 is a perspective view that schematically shows a part of the structure of the stereoscopic image display device according to the embodiment of the invention.

### DETAILED DESCRIPTION OF THE INVENTION

A display device according to an embodiment of the present invention will now be described with reference to the accompanying drawings.

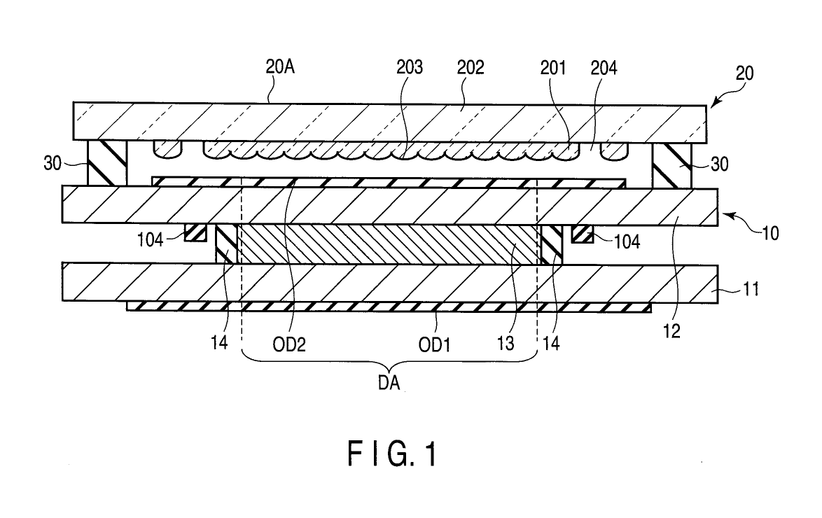

As shown in FIG. 1, the display device is configured to include a display unit 10 and a lens array unit 20 which is a light ray control element. The display unit 10 is configured such that a pair of substrates, namely, a first substrate 11 and a second substrate 12, are attached. The second substrate 12 is disposed between the first substrate 11 and the lens array unit 20.

The display unit 10 is composed of, for example, a liquid crystal display panel, a plasma display panel, an organic electroluminescence (EL) display panel or a field-emission display panel. The kind of the display panel is not limited. In this embodiment, in particular, the example in which the liquid crystal display panel is used as the display unit 10 is described.

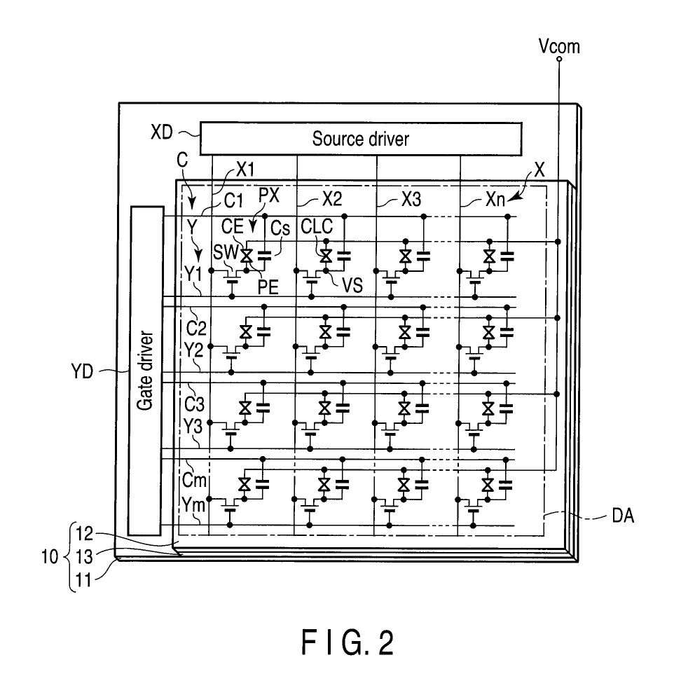

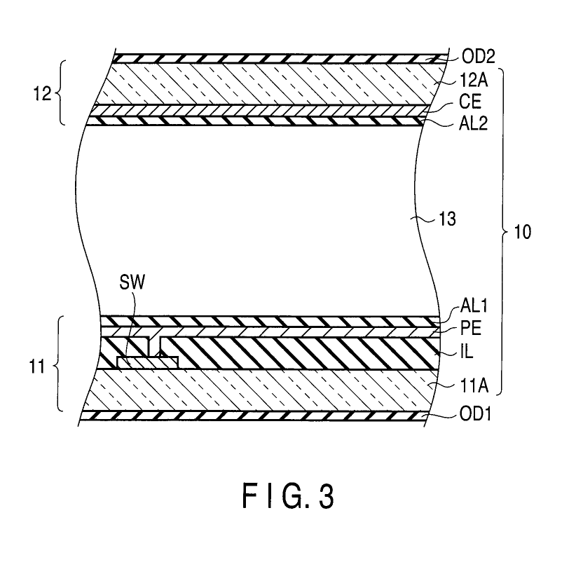

As shown in FIG. 2 and FIG. 3, the liquid crystal display panel 10 is configured to include a liquid crystal layer 13 between a pair of substrates, namely, an array substrate (first substrate) 11 and a counter-substrate (second substrate) 12, and to have a display area DA which displays an image. The display area DA is composed of a plurality of matrix-arrayed pixels PX.

The array substrate 11 is formed by using a light-transmissive insulating substrate 11A such as a glass substrate. In the array substrate 11, wiring parts for supplying driving signals to the pixels PX are provided on the insulating substrate 11A. Specifically, the array substrate 11 includes, as the wiring parts, a plurality of scanning lines Y (Y1 to Ym) and a plurality of storage capacitance lines C (C1 to Cm), which are disposed in a row direction of the pixels PX, a plurality of signal lines X (X1 to Xn) which are disposed in a column direction of the pixels PX, and switching elements SW which are disposed in association with the respective pixels PX. The array substrate 11 further includes pixel electrodes PE which are connected to the respective switching elements SW. Each of the scanning lines Y is connected to a gate driver YD which supplies a driving signal (scanning signal). Each of the signal lines X is connected to a source driver XD which supplies a driving signal (video signal).

Each of the switching elements SW is composed of, e.g. a thin-film transistor. The switching element SW is disposed at an intersection area between the scanning line Y and signal line X in association with the associated pixel PX. The gate of the switching element SW is connected to the associated scanning line Y (or formed integral with the scanning line Y). The source of the switching element SW is connected to the associated signal line X (or formed integral with the signal line X). The drain of the switching element SW is electrically connected to the associated pixel electrode PE.

Each pixel electrode PE is disposed on an insulation film IL which covers the switching element SW, and the pixel electrode PE is electrically connected to the drain of the switching element SW via a contact hole which is formed in the insulation film IL. In a transmissive liquid crystal display panel 10 which displays an image by selectively passing backlight that is radiated from a backlight unit, the pixel electrode PE is formed of a light-transmissive electrically conductive material such as indium tin oxide (ITO) or indium zinc oxide (IZO). In a reflective liquid crystal display panel 10 which displays an image by selectively reflecting ambient light (including front light emitted from a front light unit) that comes in from the counter-substrate 12 side, the pixel electrode PE is formed of a light-reflective electrically conductive material such as aluminum (Al). The surface of the pixel electrode PE is covered with a first alignment film AL1 for controlling the alignment of liquid crystal molecules included in the liquid crystal layer 13.

The counter-substrate 12 is formed by using a light-transmissive insulating substrate 12A such as a glass substrate. In the counter-substrate 12, for instance, a counter-electrode CE, which is disposed to be opposed to the plural pixel electrodes PE, is provided on the insulating substrate 12A. The counter-electrode CE is formed of a light-transmissive electrically conductive material such as ITO. The surface of the counter-electrode CE is covered with a second alignment film AL2 for controlling the alignment of liquid crystal molecules included in the liquid crystal layer 13.

The array substrate 11 and counter-substrate 12 are bonded by a sealant 14 in the state in which the pixel electrodes PE and the counter-electrode CE are opposed. A predetermined cell gap is provided between the array substrate 11 and counter-substrate 12 by spacers (not shown). The liquid crystal layer 13 is formed of a liquid crystal composition which is sealed in the cell gap between the array substrate 11 and counter-substrate 12. In the present embodiment, the liquid crystal mode is not particularly limited. Applicable modes are, for instance, a TN (Twisted Nematic) mode, an OCB (Optically Compensated Bend) mode, a VA (Vertical Aligned) mode and an IPS (In-Plane Switching) mode.

In a color display type liquid crystal display device, the liquid crystal display panel 10 includes a plurality of kinds of pixels PX, for instance, a red pixel that displays red (R), a green pixel that displays green (G), and a blue pixel that displays blue (B). Specifically, the red pixel includes a red color filter that passes light with a principal wavelength of red. The green pixel includes a green color filter that passes light with a principal wavelength of green. The blue pixel includes a blue color filter that passes light with a principal wavelength of blue. These color filters are disposed on the major surface of the array substrate 11 or the counter-substrate 12.

Each of the pixels PX includes a liquid crystal capacitance CLC between the pixel electrode PE and the counter-electrode CE. Each of the storage capacitance lines C (C1 to Cm) is capacitive-coupled to the pixel electrodes PE of the associated row, thereby constituting storage capacitances Cs.

The structure, to which the transmissive liquid crystal display panel 10 is applied, includes a backlight unit. As shown in FIG. 3, a first optical element OD1 which includes a polarizer plate is disposed on the outer surface of the array substrate 11 in association with the display area DA. Similarly, a second optical element OD2 which includes a polarizer plate is disposed on the outer surface of the counter-substrate 12.

As shown in FIG. 1, the liquid crystal display panel 10 includes alignment marks 104 on the outside of the display area DA. The alignment marks 104 are disposed on the inner surface side of the counter-substrate 12 (i.e. that surface of the counter-substrate 12, which is in contact with the liquid crystal layer). It should suffice if the alignment marks 104 are disposed on the liquid crystal display panel 10, and the alignment marks 104 may be disposed on the inner surface side of the array substrate 11 (i.e. that surface of the array substrate 11, which is in contact with the liquid crystal layer), the outer surface side of the counter-substrate 12 or the outer surface side of the array substrate 11.

The alignment marks 104 can be formed of, e.g. a color resin material, a light-blocking electrically conductive material, etc. In the case where the alignment marks 104 are formed on the inner surface of the array substrate 11 or counter-substrate 12, the alignment marks 104 can be formed of the same material at the same time as light-blocking wiring patterns or color resin patterns which the liquid crystal display panel 10 has. In short, the alignment marks 104 can be formed on the liquid crystal display panel 10, without an additional fabrication step.

The alignment marks 104 are used for alignment with the lens array unit 20, as will be described later in detail. In order to perform alignment with higher precision, it is preferable to dispose at least two alignment marks (e.g. at two locations on the same straight line or at two locations on a diagonal of the display area DA).

The lens array unit 20 is configured to include a base body 202 and a lens array layer 201 which is disposed on the base body 202. As shown in FIG. 4A and FIG. 4B, the lens array layer 201 is composed of a plurality of cylindrical lenses which are arranged in one direction. For the purpose of convenience, a direction parallel to the direction of extension of the scanning lines is referred to as an X direction, a direction parallel to the direction of extension of the signal lines is referred to as a Y direction, and a direction normal to an X-Y plane (i.e. the thickness direction of the display unit 10) is referred to as a Z direction.

In the example shown in FIG. 4A, each of the cylindrical lenses has such a shape that the generating line of the cylindrical surface of the cylindrical lens extends in the Y direction, and the plural cylindrical lenses are arranged in the X direction. In the example shown in FIG. 4B, each of the cylindrical lenses has such a shape that the generating line of the cylindrical surface of the cylindrical lens is inclined with respect to the Y direction, and the plural cylindrical lenses are arranged in the X direction.

In the lens array layer 201, the horizontal pitch Ps of cylindrical lenses is a pitch in a direction corresponding to the row direction (i.e. X direction) in the display area DA of the display unit 10. The lens array layer 201 is formed over an area that is opposed to at least the display area DA when the lens array unit 20 is disposed to be opposed to the display unit 10.

In this embodiment, the lens array layer 201 is formed on an area that is greater than the area of the display area DA. Specifically, the lens array layer 201 is formed over a length that is greater than the length of the display area DA, at least, in the X direction, and the lens array layer 201 is formed over a length that is equal to or greater than the length of the display area DA in the Y direction.

The thickness of the lens array layer 201 (i.e. the thickness from the surface of the base body 202 to the top portion of the lens) is, for example, about 0.05 mm to 0.5 mm, and the dimension of a recess between neighboring lenses is, for example, about 0.05 mm to 0.1 mm. However, these values are variable in accordance with designs.

Preferably, the base body 202 should be a flat-plate-shaped body which supports the lens array layer 201, and should have a size which is greater than the size of the lens array layer 201. The base body 202 has a thickness which is, for example, about 0.7 mm to 1.1 mm. However, where necessary, a thicker base body 202 having a thickness of about several mm may be used.

The lens array unit 20 is fixed to the display unit 10 by a support member 30 with a predetermined gap therebetween. In the example shown in FIG. 1, the lens array unit 20 is disposed such that the lens array layer 201 faces the display unit 10. It is possible to adopt such a structure that the lens array layer 201 faces the viewer side. However, in the case where the base body 202 with a large thickness is used in order to secure the durability and reliability, the lens focal distance would increase and the lens design would be restricted. Moreover, if a face glass is further disposed on the outer side in order to prevent reflection of ambient light due to the lens convex surfaces, the number of parts and the weight would increase.

Structure examples of the lens array unit 20 are described in detail. As shown in FIG. 1, the lens array unit 20 includes window portions 204. The window portions 204 are formed at positions corresponding to the positions of the alignment marks 104 of the display unit 10. Specifically, the lens array layer 201 includes cylindrical lenses 203 which are disposed outside the display area DA. The window portions 204 are formed by making use of those parts of the lens array layer 201, which are located outside the display area DA, in association with the alignment marks 104 that are disposed outside the display area DA. In particular, in the example shown in FIG. 1, the window portions 204 are formed by removing parts of the lens array layer 201, and specifically the window portions 204 are formed as recesses corresponding to the thickness of the lens array layer 201. The window portions 204 are so formed as to have flat surfaces which are opposed to the display unit 10.

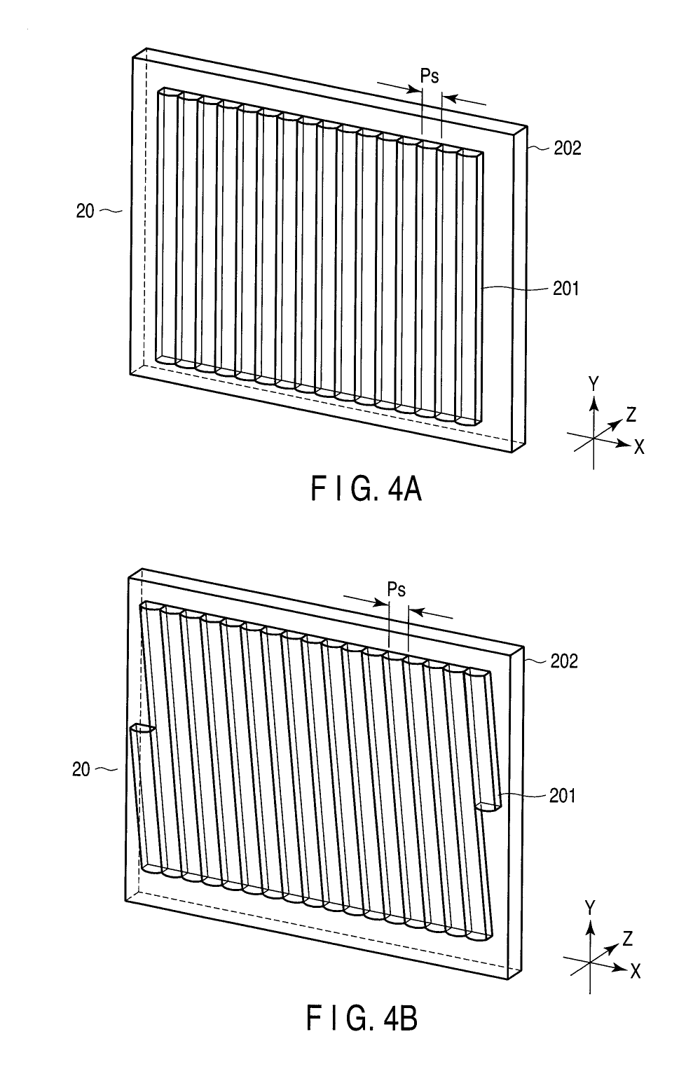

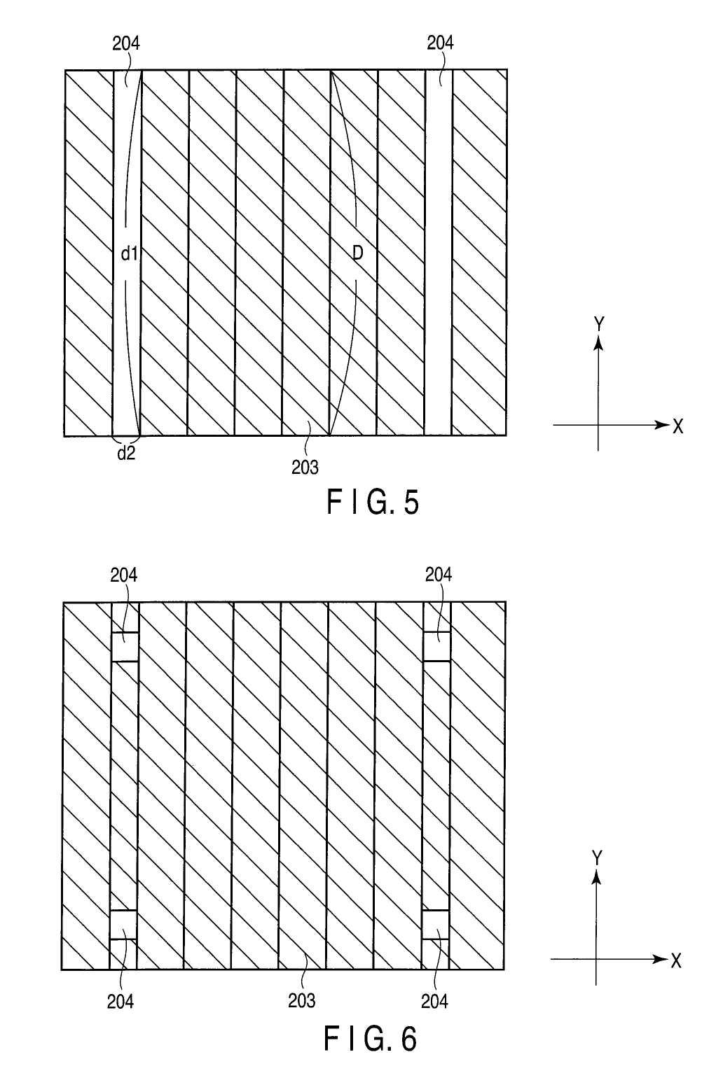

In an example shown in FIG. 5, a window portion 204 is formed along the generating line (Y direction) of the cylindrical lens 203. To be more specific, the window portion 204 is formed such that its long side d1 is parallel to the long side (generating line) D of the cylindrical lens 203, and that the long side d1 and the long side (generating line) D are substantially equal in length. The long side d1 of the window portion 204 is set to be equal to or greater than the width of the alignment mark 104 in the Y direction. The short side d2 of the window portion 204 is set to be equal to or greater than the width of the alignment mark 104 in the X direction.

In an example shown in FIG. 6, a window portion 204 is formed at a part of the cylindrical lens 203. Each side of the window portion 204 is formed to have a length that is equal to or greater than the length of each side of the associated alignment mark 104. In short, the size of the window portion 204 is set to be equal to or greater than the size of the alignment mark 104.

With the structures shown in FIG. 5 and FIG. 6, the entirety of the alignment mark 104 can be detected from the window portion 204. In particular, since the window portion 204 has no lens function, the alignment mark 104, which is detected from the window portion 204, has a size that is equal to the size of the alignment mark 104 formed on the display unit 10.

The alignment of the lens array unit 20 with the display unit 10 is described more specifically.

In the lens array unit 20, light that passes through the window portion 204 is not refracted, while light that passes through the cylindrical lens 203 is refracted. Thus, when the alignment mark 104 on the display unit 10 is observed from an upper surface 20A of the lens array unit 20 (i.e. a surface of the lens array unit 20, which is opposite to the surface thereof facing the display unit 10), the alignment mark 104 appears differently between the region where the window portion 204 is formed and the region where the cylindrical lens 203 is formed.

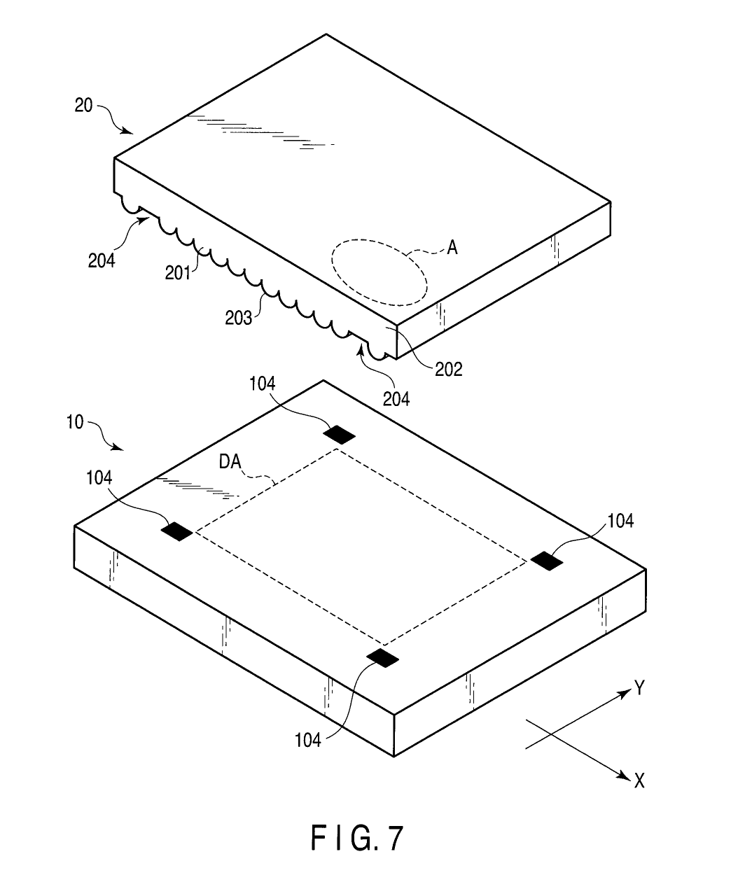

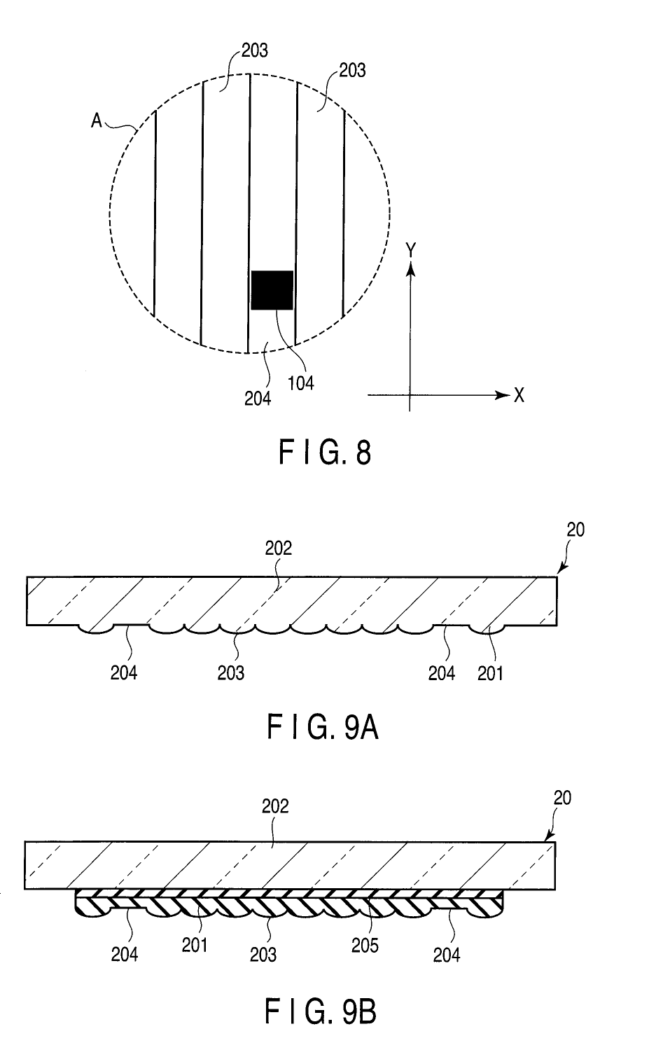

For example, in the case where the lens array unit 20 shown in FIG. 5 is aligned with the display unit 10, as shown in FIG. 7, when the window portion 204 overlaps the alignment mark 104, the entirety of the alignment mark 104 is detected with an equal size via the window portion 204, as shown in FIG. 8. In this manner, by overlapping the window portion 240 and alignment mark 104, the lens array unit 20 and display unit 10 can be aligned.

In the example shown in FIG. 7, the display unit 10 has four alignment marks 104 at four locations outside the display area DA. The precision of alignment can be improved by performing alignment so that the four alignment marks 104 may be detected from the window portions 204 of the lens array unit 20.

As regards the alignment between the display unit 10 and lens array unit 20, a slight error is tolerable in the Y direction of the cylindrical lens 203. Thus, it should suffice if the window portions 204 are formed in such a shape as to enable alignment at least in the X direction of the cylindrical lens 203. In the example shown in FIG. 5, alignment is enabled in the X direction of the cylindrical lens 203. In the example shown in FIG. 6, alignment is enabled in the X direction and Y direction of the cylindrical lens 203.

Excellent display characteristics can be realized by applying the lens array unit 20 having the window portions 204 as shown in FIG. 5 and FIG. 6. In addition, since the window portions 204 for alignment between the lens array unit 20 and display unit 10 can be formed at the same time as the processing of the lens array layer 201, neither an additional fabrication step for forming alignment marks on the lens array unit 20 nor an additional member is needed. Therefore, according to the present embodiment, an increase in cost can be suppressed.

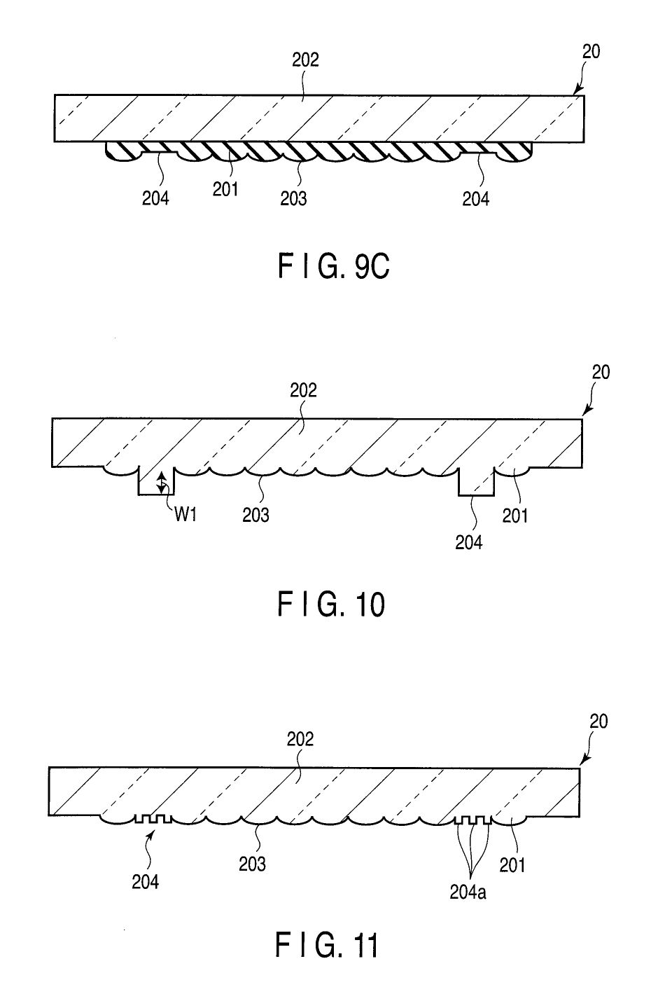

Various forms of the lens array unit 20, which are applicable to the above-described embodiment, have been proposed. Specifically, a lens array unit 20 according to an example shown in FIG. 9A is integrally formed of a glass base body 202 and a glass lens array layer 201. Specifically, in the lens array unit shown in FIG. 9A, the cylindrical lenses 203 and window portions 204 are directly formed by processing the surface of the glass substrate. The lens array unit 20 which is integrally formed of glass is advantageous in that the lens array unit 20 is less susceptible to temperature variations and can maintain a stable performance.

A lens array unit 20 according to an example shown in FIG. 9B is formed by attaching a lens array layer 201 of a resin material to a glass base body 202 via an adhesive layer 203. A lens array unit 20 according to an example shown in FIG. 9C is configured such that a lens array layer 201 of a resin material is directly molded on a glass base body 202. The lens array layer 201 of the resin material may be formed of, e.g. polymethylmethacrylate (PMMA) or polycarbonate (PC). In the examples of FIG. 9B and FIG. 9C, the cylindrical lenses 203 and window portions 204 are formed by press molding or injection molding. The resin-made lens array layer 201 is advantageous since it can be fabricated at low cost. On the other hand, since the resin material has a higher linear expansion coefficient than the glass of the base body 202, the resin material is easily affected by temperature variations. It is thus desirable to attach the lens array layer 201 to a relatively thick base body 202, thereby to suppress a variation in horizontal pitch Ps. The area of the base body 202 is slightly greater than the area of the lens array layer 201. Thus, an excess portion of the base body 202 may be used as an attachment portion for fixing the lens array unit 20 to the display unit 10.

As has been described above, the window portions 204 can be formed at the same time in the fabrication step of the lens array layer 201. Hence, an additional step for forming the window portions 204 is needless. Therefore, according to the present embodiment, a decrease in manufacturing yield can be suppressed.

Other structure examples of the window portions 204, which are applicable to the present embodiment, are described.

In the above-described embodiment, the window portion 204 is formed as a recess corresponding to the thickness of the lens array layer 201, as shown in FIG. 1. The window portion 204 is not limited to such structure examples. As a structure example in which the window portion 204 is formed to have a flat surface that is opposed to the display unit 10, the window portion 204, as shown in FIG. 10, may be formed as a projection which projects from the top of the cylindrical lens 203. Although not shown, the window portion 204 may be formed to have a flat surface, which is opposed to the display unit 10, at a position corresponding to the top of the cylindrical lens 203 or at a position corresponding to a part between the bottom and top of the cylindrical lens 203. Even in the case where the window portion 204 is formed in this fashion, the same advantageous effects as with the above-described embodiment can be obtained.

In the above-described embodiment, the window portion 204, as shown in FIG. 1, is formed to have the flat surface that is opposed to the display unit 10. The window portion 204, however, is not limited to this structure example. It should suffice if the widow portion 204 is configured such that the alignment mark 104 on the display unit 10 may appear differently between the case in which the alignment mark 104 overlaps the window portion 204 and the case in which the alignment mark 104 overlaps the cylindrical lens 203. In a structure example shown in FIG. 11, the window portion 204 has a surface with a recess-and-projection shape, which is opposed to the display unit 10. This surface with the recess-and-projection shape may be formed at a position corresponding to the bottom of the cylindrical lens, at a position corresponding to the top of the cylindrical lens, at a position corresponding to a part between the bottom and top of the cylindrical lens, or at a position projecting from the top of the cylindrical lens. Even in the case where the window portion 204 is formed in this fashion, the same advantageous effects as with the above-described embodiment can be obtained.

FIG. 10 and FIG. 11 show only examples in which the lens array layer 201 and base body 202 are integrally formed of glass, as shown in FIG. 9A. However, the same structure is also applicable to the examples shown in FIG. 9B and FIG. 9C.

Next, as an example of the display device, a display device, which can display a stereoscopic image by a one-dimensional IP method or a multi-view method, is described.

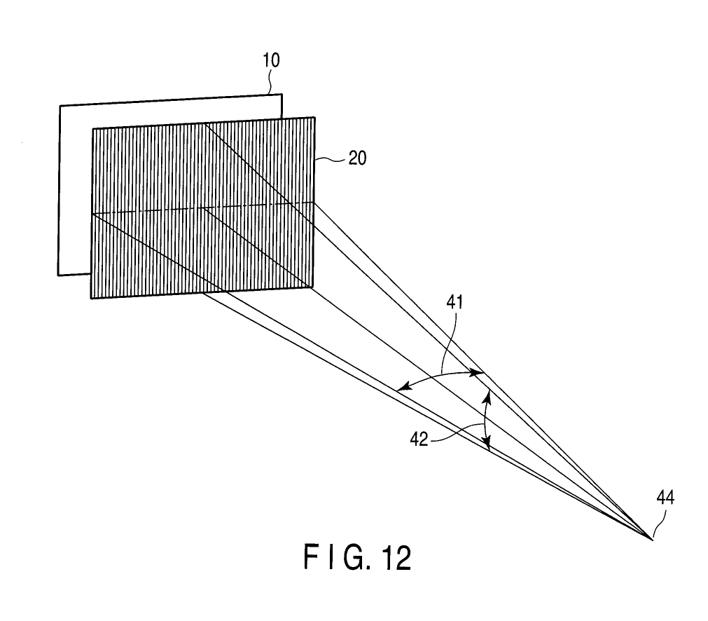

FIG. 12 is a perspective view which schematically shows the entirety of a stereoscopic video display device. The stereoscopic video display device includes a display unit 10 such as a liquid crystal display panel including an elementary image display section, and a lens array unit 20 which functions as a light ray control element having an optical aperture. The lens array unit 20 is disposed to be opposed to the elementary image display section, and performs stereoscopic display by light rays in respective directions which are based on respective lens major points of the lens array layer as reference points. At an assumed position 44 of the observer, a stereoscopic image can be observed near a front face and a back face of the lens array unit 20 in ranges of a horizontal view angle 41 and a vertical view angle 42.

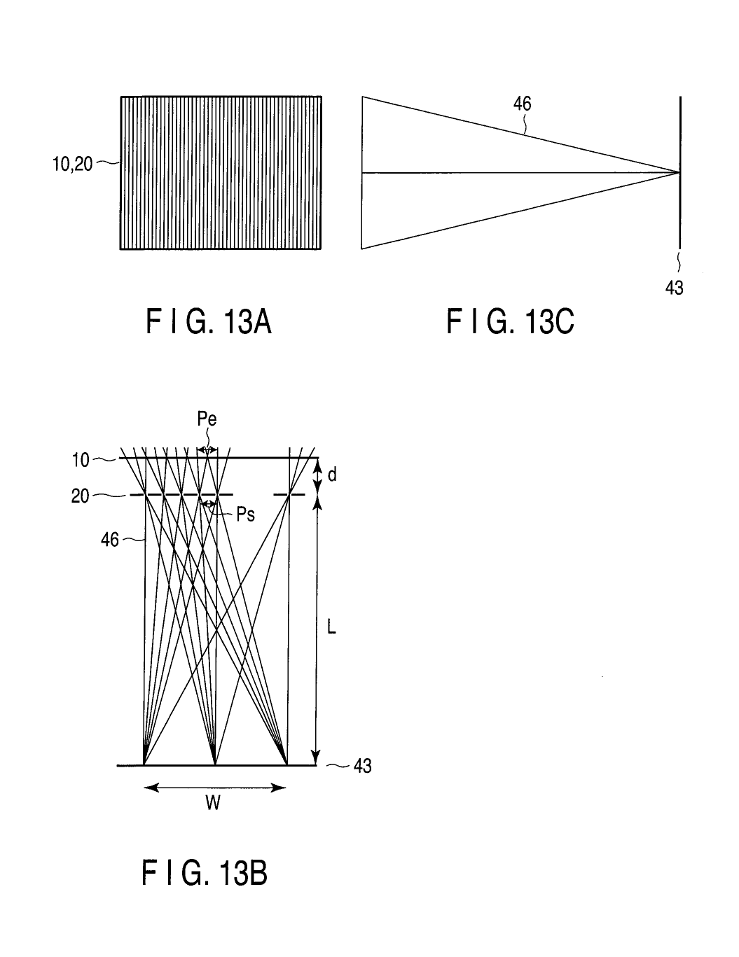

FIGS. 13A, 13B and 13C are development views that schematically show a light ray reproduction range in a vertical plane and a horizontal plane, with the display section of the stereoscopic video display device shown in FIG. 12 being set as a reference. FIG. 13A is a front view of the display unit 10 and lens array unit 20. FIG. 13B is a plan view showing an arrangement of images of the stereoscopic video display device. FIG. 13C is a side view of the stereoscopic video display device. In FIG. 13C, if the visual distance L between the lens array unit 20 and a visual distance plane 43, the horizontal pitch Ps in the lens array unit 20 and the gap d between the lens array unit 20 and the pixel plane are determined, the elementary image horizontal pitch Pe is determined by intervals with which aperture centers (or major lens points) are projected from the view point on the visual distance plane 43 onto the elementary image display plane (pixel plane). Numeral 46 denotes lines that connect visual point positions and aperture centers (major lens points), and the visual field width W is determined by the condition that elementary images do not overlap on the pixel plane. In the case of the one-dimensional IP method under the condition that pairs of parallel light rays are provided, the mean value of the horizontal pitch of elementary images is slightly greater than an integer number of times of the sub-pixel horizontal pitch, and the horizontal pitch of the lens array unit 20 is equal to the integer number of times of the sub-pixel horizontal pitch. In the case of the multi-view method, the horizontal pitch of elementary images is equal to the integer number of times of the sub-pixel horizontal pitch, and the horizontal pitch of the lens array unit is slightly smaller than the integer number of times of the sub-pixel horizontal pitch.

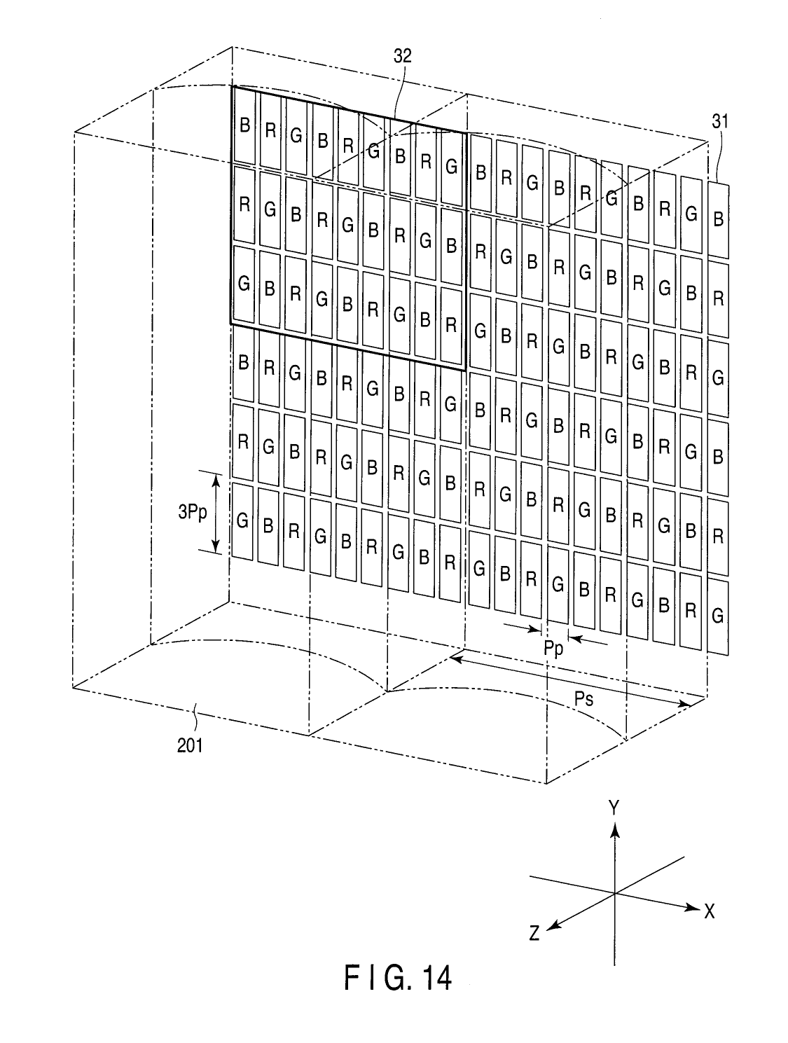

FIG. 14 is a perspective view that schematically shows the structure of a part of the stereoscopic image display device. In this case, the lens array unit (lenticular sheet) 20, which is composed of a cylindrical lens array, is disposed in front of a planar elementary image display section such as a liquid crystal display panel. As shown in FIG. 14, in the elementary image display section, sub-pixels 31 each having a vertical-to-horizontal ratio of 3:1 are arranged substantially linearly in a matrix in a horizontal direction (X direction) and a vertical direction (Y direction). The sub-pixels 31 are disposed such that red (R), green (G) and blue (B) are alternately arranged in the row direction (X direction) and column direction (Y direction). This color arrangement is generally called “mosaic arrangement”.

In the example shown in FIG. 14, one effective pixel 32 (indicated by a black-line box) at the time of stereoscopic image display, is composed of sub-pixels 31 of 9 columns×3 rows. In this structure of the display section, the effective pixel 32 at the time of stereoscopic image display, comprises 27 sub-pixels. Thus, if one parallax requires three color components, stereoscopic image/video display with 9 parallaxes in the X direction can be performed. The effective pixel, in this context, refers to a minimum-unit sub-pixel group that determines the resolution at the time of stereoscopic display, and the elementary image refers to a group of parallax component images corresponding to one lens. Accordingly, in the case of the stereoscopic video display device which is configured to employ cylindrical lenses, one elementary image includes many vertically arranged effective pixels.

As has been described above, according to the present embodiment, the lens array unit 20 and display unit 10 can be aligned while an increase in cost and a decrease in yield can be suppressed. Therefore, a display device with excellent display characteristics can be provided.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

For example, in the above-described embodiment, the alignment mark has a rectangular shape and the window portion also has a rectangular shape. The shapes of the alignment mark and window portion, however, are not limited to the rectangular shapes. For example, each of the alignment mark and window portion may have a polygonal shape such as a triangular shape, a circular shape, an elliptic shape or a crisscross shape.

What is claimed is:

1. A display device comprising:
a lens array unit including a lens array layer; and
a display unit configured such that a first substrate and a second substrate, which is disposed between the first substrate and the lens array unit, are attached, the display unit including a display area and an alignment mark outside the display area,
wherein the lens array unit includes a window portion formed at a position on the lens array layer, which corresponds to the alignment mark.

2. The display device according to claim 1, wherein the lens array layer includes a plurality of cylindrical lenses which are arranged in one direction, and the window portion is formed along a generating line of each of cylindrical lenses.

3. The display device according to claim 1, wherein the window portion is formed at a part of the cylindrical lens.

4. The display device according to claim 1, wherein the window portion is formed to have a flat surface which is opposed to the display unit.

5. The display device according to claim 1, wherein the window portion is formed to have a surface with a recess-and-projection shape, which is opposed to the display unit.

6. The display device according to claim 1, wherein the lens array unit is one of a lens array unit which is formed by integrally forming a glass base body and the lens array layer of glass, a lens array unit which is formed by attaching the lens array layer of a resin material to a glass base body via an adhesive layer, and a lens array unit which is formed by directly molding the lens array layer of a resin material on a glass base body.

7. The display device according to claim 1, wherein the display unit is a liquid crystal display panel.

8. The display device according to claim 1, wherein the alignment mark is formed of the same material as a light-blocking wiring pattern or a color resin pattern, which the display unit has.
